(19) United States
(12) Patent Application Publication
(10) Pub. No.: US 2003/0100287 A1
(43) Pub. Date: May 29, 2003

(54) Radiocommunication module in the form of an electronic macro-component , corresponding interface structure and transfer method onto a motherboard

(76) Inventors: Bachir Kordjani, Montigeny Le Bretoneux (FR); Jacky Jouan, Sevres (FR)

Correspondence Address: Robert M Angus, Westman Champlin & Kelly, International Centre Suite 1600, 900 Second Avenue South, Minneapolis, MN, 55402-3319, US

(21) Appl. No.: 10/182,604

(22) PCT Filed: Jan. 26, 2001
(86) PCT No.: PCT/FR01/00260

(30) Foreign Application Priority Data
Jan. 31, 2000 (FR) 00/01264
Feb. 18, 2000 (FR) 00/02069

(51) Int. Cl. H04B 1/08

(52) U.S. Cl. 455/349; 455/300; 455/90

(57) ABSTRACT

Module for radiocommunication equipment intended to be transferred onto a motherboard and comprising components mounted on a printed circuit and ensuring at least one of the following functions: RF processing, numerical processing, and analog processing. It comprises a set of conductive elements distributed on the lower face of the said printed circuit, and embodied such that the said set of conductive elements constitutes at the same time:

means for electromagnetic screening of the lower face of the printed circuit;

electrical interconnection means, ensuring the passage of electrical signals toward and/or from the motherboard; and

means for transfer of the radiocommunication module onto the motherboard;

such that the radiocommunication module forms an electronic macro-component.

The field of the invention is that of radiocommunications.

More precisely, the invention relates to radiocommunication equipment (radiotelephone, and more particularly any apparatus or device carrying out radiocommunication), and more particularly to radiocommunication modules intended for these equipments.

Conventionally, most radiocommunication equipments comprise a radiocommunication module having a card, that is, a printed circuit, onto which components are soldered, a screening structure, and a mechanical connector enabling the interconnection of the module with other elements such as a motherboard.

The components soldered to the printed circuit can in particular provide numerical processing, analog processing, and/or radiofrequency processing functions. The screening structure enables the radiocommunication module to be electromagnetically screened, and is conventionally constituted by two enclosures, respectively disposed on each face of the integrated circuit, and two covers, which can be respectively clipped to each face of the module.

A conventional architecture for GSM type radiocommunication modules consists of an electronic card, embodied on an organic substrate and enclosed in a metallic enclosure ensuring the electromagnetic screening function. This card is interconnected via card-to-card type connectors or card-to-cable type connectors. The card can then be transferred onto a motherboard, either mechanically with screws, or by soldering metallic pins.

In the field of radiocommunication, one of the main preoccupations of manufacturers is to design and produce components and modules which are more compact, with reduced cost, and with very simple mounting, and particularly as regards transfer onto a printed circuit or a motherboard.

Specialists in radiocommunications have envisaged several solutions in order to attain these three objects.

Thus Ericsson (Trademark) has offered a radiofrequency module comprising an integrated circuit embodied on a ceramic substrate, in which solder beads or columns are used to simultaneously provide for the passage of electrical signals and the transfer of the module onto a motherboard using a surface mount (CMS) technology.

IBM (Trademark) has likewise proposed the design of a radiofrequency component in which a first row of solder beads ensures the passage of electrical signals and a second row of solder beads enables the screening of the component, these beads furthermore permitting the component to be soldered to a circuit.

Other makers in the electronic field have considered designing hybrid modules comprising several components of assembly level “1”. for which the solder beads or columns simultaneously fulfill the functions of electrical interconnection and of transferring the module onto a motherboard.

However, despite numerous research efforts attempting to satisfy the three criteria of low cost, small size, and easy mounting and transfer, it has not yet been possible to design a radiocommunication module which fulfills these three economic and technical objects.

A disadvantage of the prior art techniques is in particular that the transfer of radiocommunication modules onto a motherboard is not effected in the standard manner, according to a remelting technique similar to that used for soldering a component to a card.

Another disadvantage of these prior art techniques is that the radiocommunication modules obtained according to one of these techniques are very thick.

Yet another disadvantage of these prior art techniques is that the radiocommunication modules obtained according to one of these techniques are expensive.

The invention has as its object to remedy these disadvantages of the prior art.

More precisely, the invention has as its object to provide a radiocommunication module of reduced cost.

Another object of the invention is to implement a radiocommunication module having a low thickness.

Yet another object of the invention is to provide a radiocommunication module which can be transferred onto a motherboard by a standard remelting technique, similar to that used for fixing surface mounted components, so as to be able to provide a transfer under high-volume industrial conditions.

These objects, as well as others which will become apparent hereinafter, are attained by the invention by means of a module for radiocommunication equipment, intended to be transferred- to a motherboard and comprising components mounted on a printed circuit and providing at least the following functions: RF processing, numerical processing, and analog processing, comprising: a set of conductive elements, distributed on the lower face of the printed circuit and implemented in a manner such that the set of conductive elements constitutes, at one and the same time:

means for electromagnetic screening of the lower face of the printed circuit;

electrical interconnection means, ensuring the passage of electrical signals to and/or from the motherboard; and

means for transferring the radiocommunication module onto the motherboard;

such that the radiocommunication module forms an electronic macro-component.

By “component” there is understood here any type of component, and especially components of assembly level “1” (unitary components, such as a chip, a capacitor, a resistor, an inductance, etc.) as well as components of assembly level “2” (more complex components, such as boxes or integrated circuits).

The invention is thus based on a completely new and inventive approach to the design of radiocommunication modules, simultaneously satisfying the criteria of low cost, low bulk, and ease of transfer onto a motherboard.

In the field of electronics, and even more so in that of radiocommunications, those skilled in the art are always reluctant to use a single element to fulfill distinct functions. In this field, interactions between elements and/or components are very strong, and thus often make the operation of a complex module unpredictable. Such a prediction is the more difficult, the more the module contains a large number of components, and in addition, the more a single element of the module can accumulate several distinct functionalities.

The combination of two functions, such as electrical interconnection and electromagnetic screening, for example within the same element such as a solder bead, and even more so, the use of a single set of conducting elements to simultaneously implement electrical connection, electromagnetic screening, and the transfer of the module to on a motherboard, thus results from a complex approach.

Those skilled in the art who envisaged such a triple combination of functionalities within a single element would of course be naturally inclined to reject this solution for technical reasons of non-feasibility or lack of control of the effects due to each of the functionalities. A radiocommunication module comprises, on the one hand, components of the “1” and “2” assembly level, and on the other hand, a printed circuit, which can be multi-face. Such a module thus generally undergoes several steps termed remelting, and those skilled in the art consider that it is not possible to carry out more than two remeltings (otherwise, certain previously soldered components could become detached during this supplementary step. Furthermore, each remelting process causes premature and considerable ageing of the soldered joints).

According to an advantageous characteristic of the invention, the radiocommunication module is comprised in a device belonging to the group comprising:

radiocommunication terminals;

devices other than radiocommunication terminals, necessitating a wireless communication functionality;

modems.

Thus the module implemented according to the invention finds numerous applications in the field of radiocommunications, and can especially be used in radiocommunication terminals such as mobile telephones, for example.

Advantageously, the set of conductive elements comprises a first subset of conductive elements providing electromagnetic screening of the module, and a second subset of conductive elements, providing electrical interconnection, the first and second subsets of conductive elements together providing for transfer to the motherboard.

In contrast to the prior art techniques, the same set of conductive elements thus simultaneously carries out the three functions of electromagnetic screening, electrical interconnection, and transfer to the motherboard. Such a triple combination of functionalities thus enable the bulk and cost of the radiocommunication module to be reduced.

According to one advantageous technique of the invention, the conductive elements belong to the group consisting of:

columns;

beads;

deposits of solder and/or of brazing paste;

inserts;

quadrants.

By “quadrants” are understood here, component pads having a quadrant shape. The use of solder beads can also be envisaged, or preferably of solder columns, taking up less space, can thus be envisaged. These solder beads or columns do not melt (for example, high temperature solder). Indeed, the solder columns enable a sufficient height to be provided between the motherboard and the lower face of the printed circuit, thus avoiding contact between the components fixed to the lower face of the printed circuit and the motherboard, while the said columns occupy a small surface area of the printed circuit and of the motherboard.

More generally, the conductive elements distributed on the lower face of the printed circuit can consist of any type of conductive contact permitting a mechanical and electrical joint to be effected between the radiocommunication module, shown in the form of an electronic macro-component, and a motherboard.

According to an advantageous embodiment of the invention, the radiocommunication module comprises an interface structure, a first face of which supports the set of conductive elements so as to permit a transfer of the interface structure, by its first face, onto the lower face of the printed circuit, the interface structure being transferred by its second face onto the motherboard.

Such an interface structure permits maintaining a minimum distance between the radiocommunication module and the motherboard, and more precisely between the lower face of the printed circuit and the motherboard, so that the components fixed to the lower surface of the printed circuit are not in contact with the motherboard. Such a distance can be substantially of the order of 1.5 mm, or a smaller distance.

In addition, the interface structure is chosen so as to have a thermal expansion coefficient which is compatible with the thermal expansion coefficient of the radiocommunication module, so as to avoid possible shear problems.

According to an advantageous characteristic, the elements supported by the first face of the interface structure pass through and project on the second face of the interface structure, so as to permit the transfer of the interface structure, by its second face, onto the motherboard.

According to another advantageous characteristic of the invention, each of the elements supported by the first face of the interface structure is connected to a first end of a conductive through opening, a second end of each through opening being connected to an element of a complementary set of conductive elements distributed over the second face of the interface structure, the complementary set of conductive elements permitting the transfer of the interface structure, by its second face, onto the motherboard.

According to an advantageous embodiment, the interface structure can be removed after the radiocommunication module has been transferred to the motherboard.

Thus it can be envisaged, for example, that the interface structure is removed after the mounting of the module on the motherboard, for example by a technique of chemically disintegrating the structure.

The printed circuit is advantageously embodied with an organic substrate. Organic substrates are generally less expensive than other types of substrates, particularly ceramic substrates.

According to another advantageous characteristic, the printed circuit belongs to the group comprising:

single-face, single-layer printed circuits;

multi-face, single-layer printed circuits;

single-face, multi-layer printed circuits;

multi-face, multi-layer printed circuits.

The radiocommunication module can attain a high level of complexity and can comprise a large number of components, on both the lower and the upper face of the printed circuit, it being possible to superpose, on several layers in the printed circuit, the electrical connections between the different components. Alternatively, the radiocommunication module can be less complex and can be constituted by a single-face, single-layer printed circuit. Thus the invention is adapted to all types of multi-component modules.

The invention likewise relates to the interface structure, permitting the transfer of a radiocommunication module onto a motherboard, with a first face of the interface structure supporting a set of conductive elements permitting a transfer of the interface structure, by its first face, onto the lower surface of a printed circuit comprised in the radiocommunication module, the interface structure being transferred by its second face onto the motherboard.

The invention furthermore relates to a process of transferring a radiocommunication module onto a motherboard, the components of the module being soldered to a printed circuit during at least one remelting step, the process comprising at least one supplementary remelting step, enabling the radiocommunication module to be transferred onto the motherboard.

According to another advantageous embodiment, the radiocommunication module comprising an interface structure, a first face of which supports a set of conductive elements, the said at least one first remelting step of the process likewise enables the transfer of the interface structure, by its first face, onto the lower face of the printed circuit, and the supplementary remelting step permits the transfer of the interface structure, by its second face, onto the motherboard.

Other characteristics and advantages of the invention will become more clearly apparent on reading the following description of a preferred embodiment, given simply by way of an illustrative and non-limitative example, and from the accompanying drawings.

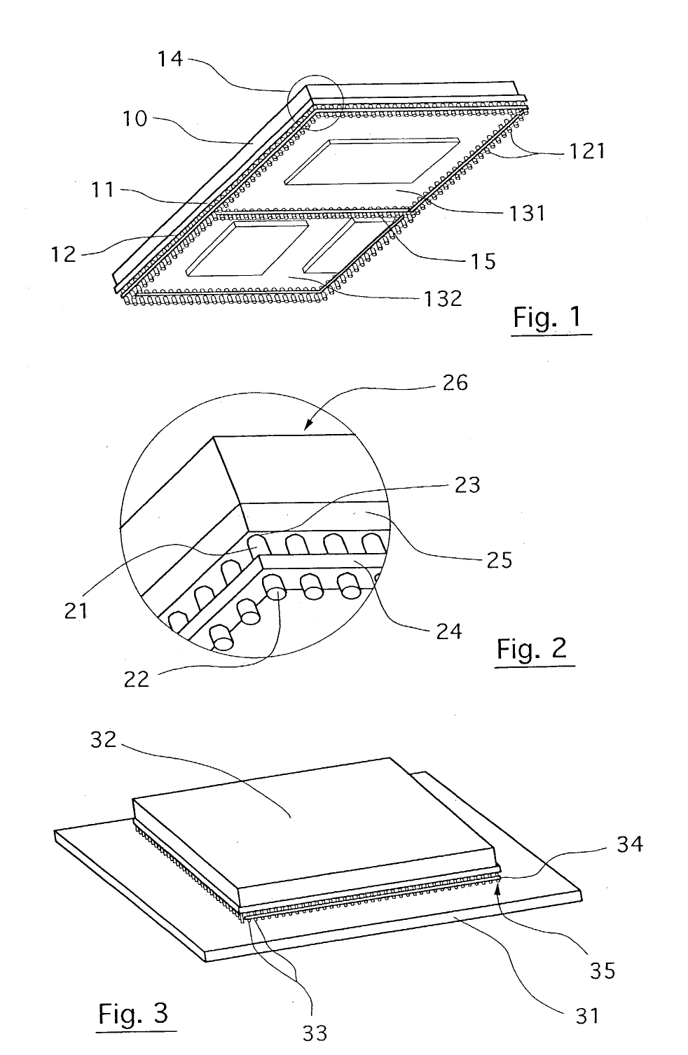

FIG. 1 shows a radiocommunication module according to the invention, seen from below;

FIG. 2 illustrates a detail of the zone 14 of FIG. 1;

FIG. 3 shows the module of FIG. 1 after transfer onto a motherboard.

The general principle of the invention is based on the utilization of an assembly of conductive elements to implement the three functionalities of electromagnetic screening, electrical interconnection, and transfer onto a motherboard.

An embodiment of a radiocommunication module according to the invention is shown in relation to FIG. 1.

The radiocommunication module 10 comprises a printed circuit 11 to which an interface structure 12 has been fixed. The printed circuit 11 has two zones 131 and 132, respectively corresponding, for example, to a radiofrequency processing zone and to a numerical and/or baseband processing zone. These two zones process very different types of signals; they are advantageously isolated by a row 15 of metallic columns. The interface structure 12 has a set of conductive elements 121 particularly permitting the transfer of the structure 12 onto the lower face of the printed circuit 11. A zone 14 is illustrated in detail on a scale 15 in FIG. 2.

In the example described, the conductive elements are columns. A metallic column 21 passes through an intervening member 24, which can for example be made of plastic with a thickness substantially equal to 0.5 mm. The metallic column 21 can be fixed to the lower face of the printed circuit 25 by a high temperature solder 23. The module 26 can be joined to a motherboard by a standard soldering 22 of the column 21. A column 21 can have a length substantially equal to 1.5 mm and a diameter substantially equal to 0.4 mm. The spacing between two successive columns 21 can be equal to 1.27 mm.

The columns can be replaced by various elements, such as solder beads, inserts, quadrants, deposits of brazing paste, etc.

According to another embodiment of the invention, the interface structure can be joined to the printed circuit, on the one hand, and to a motherboard on the other hand, for example by means of two conductive elements, for example, plugs of brazing paste, deposited on each of the faces of the intervening member 24, these two elements being connected by a hole which is metallized, for example with copper. The two plugs of brazing paste then have a thickness such that the distance between the lower face of the printed circuit and the motherboard is substantially equal to 1.5 mm.

The interface structure can be permanent or temporary. In the latter case, it can be removed by chemical disintegration after transfer of the motherboard. It is likewise possible that there is no interface structure.

FIG. 3 shows the radiocommunication module of FIG. 1 after transfer onto a motherboard 31. An interface structure 34 is fixed to the radiocommunication module 32 on the one hand, and to the motherboard 31 on the other hand. The soldering 33 between the motherboard 31 and the metallic columns 35 of the interface structure 34 can be of the surface mount type.

1. Module for radiocommunication equipment, intended to be transferred onto a motherboard and comprising components mounted on a printed circuit and ensuring at least one of the following functions: RF processing, numerical processing, and analog processing,
wherein it comprises a set of conductive elements distributed on the lower face of the said printed circuit, and embodied such that the said set of conductive elements constitutes at the same time:
means for electromagnetic screening of the lower face of the said printed circuit;
electrical interconnection means, ensuring the passage of electrical signals toward and/or from the said motherboard; and
means for transfer of the said radiocommunication module onto the said motherboard;
such that the said radiocommunication module forms an electronic macro-component.

2. Radiocommunication module according to claim 1, wherein it is comprised in a device belonging to the group comprising:
radiocommunication terminals;
devices, other than radiocommunication terminals, necessitating a functionality of wireless communication;
modems.

3. Radiocommunication module according to claim 1, wherein the said set of conductive elements comprises a first subset of conductive elements providing the said electromagnetic screening, and a second subset of conductive elements providing the said electrical interconnection,
and wherein the said first and second subsets of conductive elements together provide the said transfer onto the motherboard.

4. Radiocommunication module according to claim 1, wherein the said conductive elements belong to the group comprising:
columns;
beads;
deposits of solder and/or of brazing paste
inserts
quadrants

5. Radiocommunication module according to claim 1, wherein it comprises an interface structure of which a first face supports the said set of conductive elements so as to permit a transfer of the said interface structure by its first face onto the lower face of the said printed circuit,
and wherein the said interface structure is transferred by its second face onto the motherboard.

6. Radiocommunication module according to claim 5, wherein the said elements supported by the first face of the interface structure pass through and project on the second face of the interface structure, so as to permit the said transfer of the interface structure, by its second face, onto the motherboard.

7. Radiocommunication module according to claim 5, wherein each of the said elements supported by the first face of the interface structure is connected to a first end of a conductive through opening, a second end of each through opening being connected to an element of a set of complementary conductive elements distributed on the second face of the interface structure, the said set of complementary conductive elements permitting the said transfer of the interface structure, by its second face, onto the motherboard.

8. Radiocommunication module according to claim 5, wherein the said interface structure can be removed after the said radiocommunication module has been transferred onto the motherboard.

9. Radiocommunication module according to claim 1, wherein the said printed circuit is embodied with an organic substrate.

10. Radiocommunication module according to claim 1, wherein the said printed circuit belongs to the group comprising:
single-face, single-layer printed circuits;
multi-face, single-layer printed circuits;
single-face, multi-layer printed circuits;
multi-face, multi-layer printed circuits.

11. Interface structure enabling the transfer of a radiocommunication module onto a motherboard, wherein a first face of the said interface structure supports a set of conductive elements permitting a transfer of the interface structure, by its first face, onto the lower face of a printed circuit comprised in the said radiocommunication module,
and wherein the said interface structure is transferred by its second face onto the motherboard.

12. Process of transferring onto a motherboard a radiocommunication module according to any one of previous claims, the said components being soldered onto the said printed circuit during at least one remelting step,
wherein the said process comprises at least one supplementary remelting step, enabling the transfer of the said radiocommunication module onto the said motherboard.

13. Process according to claim 12, the said radiocommunication module comprising an interface structure of which a first face supports the said set of conductive elements,
wherein the said at least one first remelting step likewise enables the transfer of the said interface structure, by its first face, onto the lower face of the said printed circuit,
and wherein the said supplementary remelting step enables the transfer of the said interface structure, by its second face, onto the motherboard.
